(19) United States
(12) Patent Application Publication
(10) Pub. No.: US 2011/0247768 A1
(43) Pub. Date: Oct. 13, 2011

(54) Child-Resistant Roller Blind Apparatus

(76) Inventor: Jae-Suk Kwak, Gyeonggi-do (KR)

(21) Appl. No.: 12/777,601

(22) Filed: May 11, 2010

(30) Foreign Application Priority Data
Apr. 13, 2010 (KR) 10-2010-0033601

(51) Int. Cl. E06B 9/80

(52) U.S. Cl. 160/319

(57) ABSTRACT

A child-resistant roller blind apparatus is provided in which a roller blind is operated only when a safety hook of a cord or a ball chain, which is coupled with an elastic gear, is fixedly mounted after being tightened, so that a safety accident by the ball chain is completely prevented, improving the safety.

This application claims all benefits of Korean Patent Application No. 10-2010-0033601 filed on Apr. 13, 2010 in the Korean Intellectual Property Office, the disclosures of which are incorporated herein by reference.

### BACKGROUND OF THE INVENTION

1. Field of the Invention

The present invention relates, in general, to a child-resistant roller blind apparatus and, more particularly, to a child-resistant roller blind apparatus in which a roller blind is operated only when a safety hook of a cord or a ball chain, which is coupled with an elastic gear, is fixedly mounted after being tightened, so that a safety accident by the ball chain is completely prevented, improving the safety, and that a person is inspired with safety mind that he/she should operate the roll blind after fixedly mounting the safety hook, thereby previously preventing a safety accident.

2. Description of the Related Art

Generally, roller blinds are used instead of curtains in offices, homes or restaurants in order to block light passing through a window or the like. The roller blinds are operated so that, when a ball chain that is connected in a round form with a sprocket, which is provided on one side of a mounting bracket, is pulled down in one direction, a roller blind which is composed of fabric or synthetic resin is lowered down while being released from a winding pulley, due to the elastic force of a spring, and is fixed to a certain position.

The roller blind 10, as shown in FIG. 1, includes a rotary member 5 and a reduction member 8, which are respectively mounted on opposite brackets 9, and a winding pulley which covers the outsides of the rotary member and the reduction member and around which a roller blind is wound.

The rotary member 5 is configured such that a connecting shaft 3 having a rotating section 2 is installed in front of a rotating body 1, that a spring 4 is inserted around the connecting shaft 3, that opposite ends of the spring 4 are respectively connected with the rotating body 1 and the rotating section 2, and that the rotating section 2 allows the connecting shaft 3 to move laterally using the elasticity of the spring 4.

The reduction member 8 is configured such that a reducer 6 is mounted in front of a rotating body 1 having an adjuster and that a fixing shaft 7 having a reduction nut 7a is coupled in front of the reducer.

In the rotating body 1, as shown in FIG. 2, a sprocket 11 around which a ball chain 9a is engaged is installed on a fixing plate having a rotatable fixing shaft 12.

The winding pulley around which the roller blind is wound is coupled on the outside of the opposite rotating bodies 1, and the bracket 9 is fixedly mounted on a window frame or the like using a screw or the like.

In operation of the roller blind, when the ball chain 9a engaged with the sprocket 11 is pulled down in one direction, the roller blind is lowered down to block light, and when the ball chain 9a is pulled down in opposite direction, the roller blind is raised to make the window clear.

Since the conventional roller blind is operated in a state that the ball chain mounted on one side is not fixed, but freely movable, accidents often occur that for example, necks of children or infants are trapped in the trailing ball chain during playing in the home.

To solve this problem, it has been proposed that a hook is coupled with the ball chain and used while being fixed to a wall face or window frame. However, since the hook only serves to fix the ball chain, the roller blind can also be operated freely according to the user's choice even when the hook is not fixed. That is, the hook does not inspire the user to essentially tighten the hook to the wall face.

### SUMMARY OF THE INVENTION

Accordingly, the present invention has been made keeping in mind the above problems occurring in the related art, and the present invention is intended to propose a child-resistant roller blind apparatus in which a roller blind is operated only when a safety hook of a ball chain, which is coupled with an elastic gear, is fixedly mounted after being fixed tight to a wall face or a window frame, so that a safety accident by the ball chain is completely prevented, improving the safety.

In order to achieve the above object, according to one aspect of the present invention, there is provided a child-resistant roller blind apparatus including: an elastic gear consisting of symmetrical upper and lower gear half-bodies to be coupled with each other, each body having a plurality of ball-chain holes on the outer circumference, a half coupling hole with an engaging recess on the inner circumference, and an arcuate protrusion on the surface; an elasticity-acting section having one or more engaging protrusions on the upper half body for receiving a compression spring therein, and one or more engaging grooves on the lower half body for receiving the engaging protrusions therein, so that, when moved upwards by means of the elasticity by the compression spring, the upper half body prevents the elastic gear from rotating; and a safety hook which has elasticity by a spring and is mounted on a ball chain, which is engaged with the ball-chain holes of the elastic gear, and then pulled down and fixedly connected to a wall surface so that interruption in rotation of the elastic gear is released by the tension of the ball chain and is able to rotate.

According to the above construction, the present invention has the following effects.

First, since the roller blind can be operated only when the safety hook is drawn tight and then fixed to a certain portion, the ball chain or a cord is continuously maintained in a tight state, thereby completely preventing a safety accident.

Second, the roller blind inspires a user with safety mind that he/she has to fixedly mount the safety hook in order to use the roller blind, thereby preventing an accident by the ball chain.

Third, elastic gear having diverse forms is used, so that the roller blind can be operated in a safe manner.

### BRIEF DESCRIPTION OF THE DRAWINGS

The above and other objects, features and advantages of the present invention will be more clearly understood from the following detailed description when taken in conjunction with the accompanying drawings, in which:

FIGS. 1 and 2 are perspective views illustrative of the construction of a conventional roller blind;

FIG. 3 is a cross-sectional view illustrative of the entire construction of a roller blind apparatus according to the present invention;

FIGS. 4 and 5 are a perspective view and a cross-sectional view illustrative of the construction of an elastic gear of the roller blind apparatus according to the present invention;

FIGS. 6 to 8 are cross-sectional views illustrative of the construction of the elastic gear according to another embodiment of the present invention;

FIG. 9 is a perspective view illustrative of the construction of a rotating section which is coupled with the elastic gear according to the present invention;

FIG. 10 is view illustrative of the construction of a fixing plate to which the elastic gear is coupled according to the present invention;

FIG. 11 is a bottom view illustrative of a cover to be coupled with the fixing plate according to the present invention;

FIG. 12 is a cross-sectional view illustrative of the construction of a safety hook according to the present invention;

FIG. 13 is a view illustrative of the operation of the roller blind apparatus according to the present invention; and

FIGS. 14 and 15 are views illustrative of the operation of the roller blind apparatus according to another embodiment of the present invention.

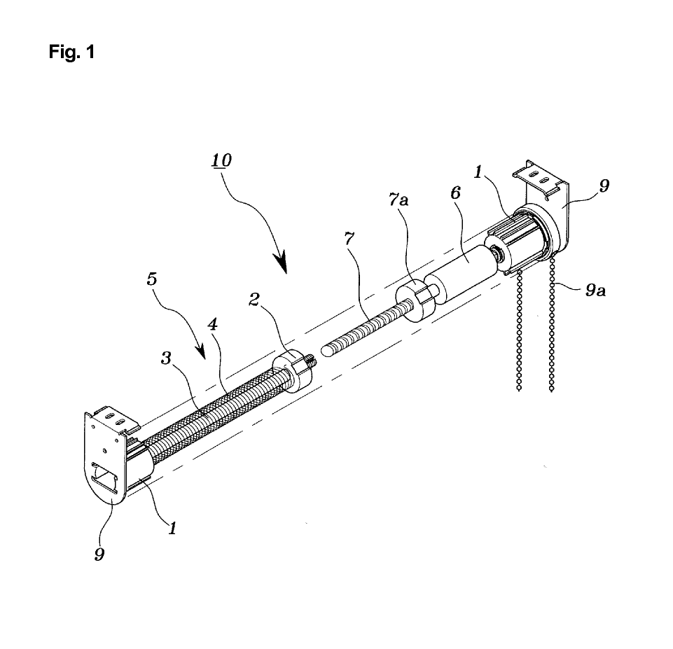

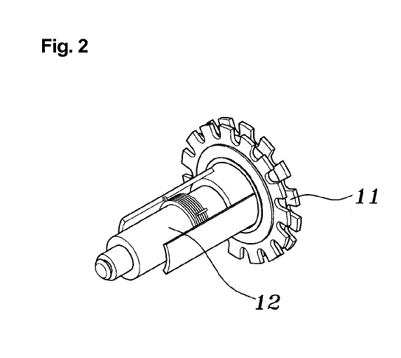

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

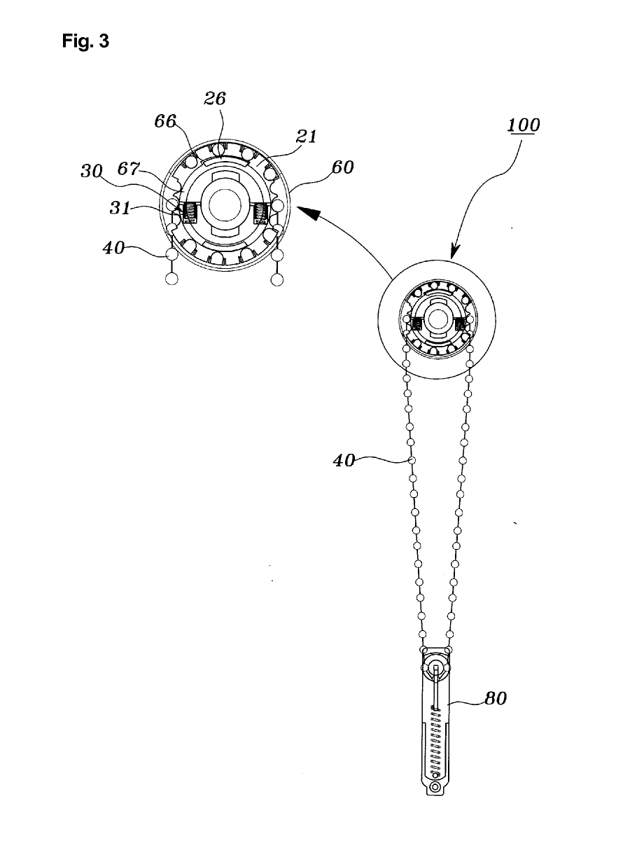

FIG. 3 is a cross-sectional view illustrative of the entire construction of a child-resistant roller blind apparatus according to the present invention, wherein reference number 100 denotes a main body of the roller blind apparatus.

The main body 100 includes an elastic gear 20 having a plurality of ball-chain holes 23 on the outer circumference with which a ball chain 40 is engaged, and a safety hook 70 which is coupled with the ball chain 40 so as to release the interrupted state of the elastic gear 20. The elastic gear may consist of two or more divisions which are to be coupled into one piece.

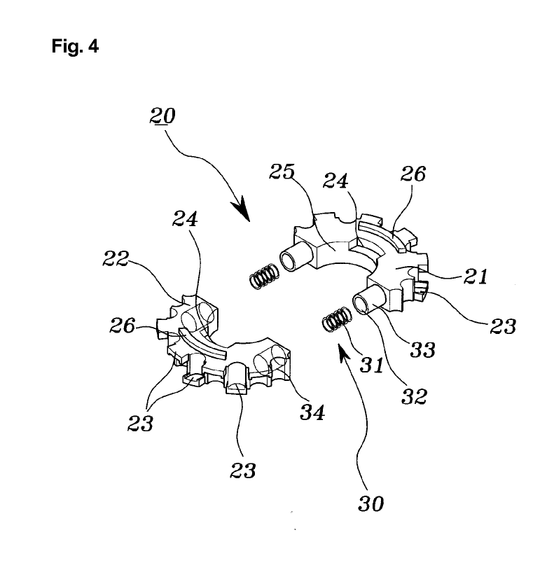

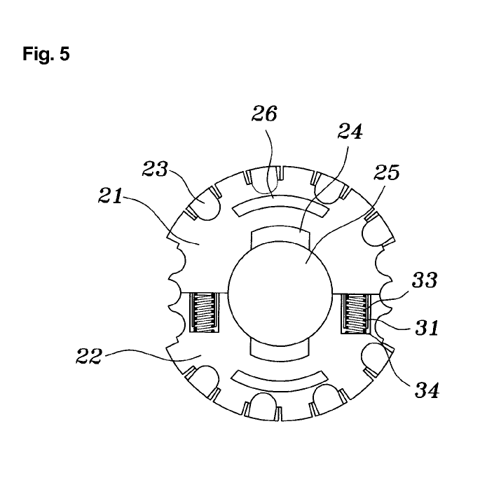

For example, as illustrated in FIGS. 3 to 5, the elastic gear 20 consists of two half circular sections, i.e. upper and lower half-bodies 21 and 22, which are to be coupled with each other.

The upper and lower half bodies 21 and 22 are arranged symmetrically and respectively have the ball-chain holes 23 on the entire outer circumference, with which the ball chain 40 is engaged, and a semicircular coupling hole 25 having an engaging recess 24 shaped like a ‘ [symbol] ’.

Further, the elastic gear 20 has on one surface thereof opposite arcuate guide protrusions 26, which are symmetrically arranged.

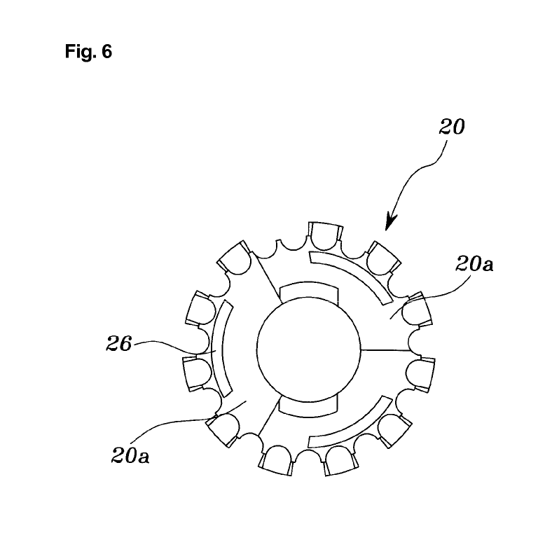

Moreover, as illustrated in FIG. 6, the elastic gear 20 may consist of two or more divisions 20a, which are to be coupled into one piece.

The respective divisions 20a respectively have coupling protrusions on one surface.

The upper and lower half bodies 21 and 22 define an elasticity-acting section 30 at a contact surface between them. The elasticity-acting section 30 is configured such that the upper half body 21 has a coupling protrusion 33 with an engaging recess 32, into which a compression spring 31 is inserted, and the lower half body has an insertion hole 34, into which the coupling protrusion 33 is inserted.

In such a construction, when the upper half body 21 is moved upwards by means of elasticity by the compression spring 31, it is bound to a fixing plate 60, which will be explained later, thereby being in the state preventing the elastic gear 20 from rotating.

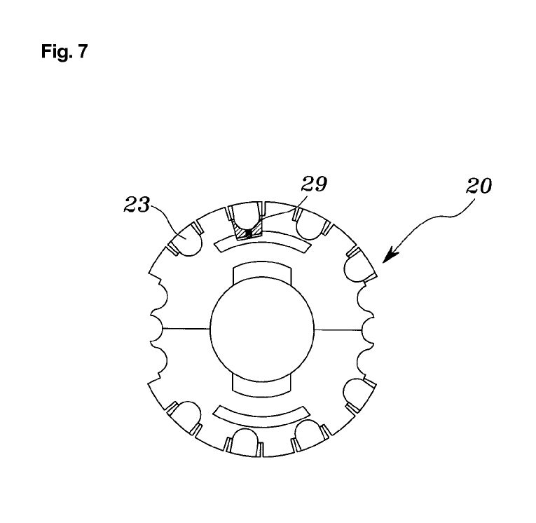

In the elasticity-acting section, as illustrated in FIG. 7, an elastic spring 29 is provided on a lower side of one or more ball-chain holes 23 among plural ball-chain holes 23, which are formed on the outer circumference of the elastic gear 20.

The elastic spring 29 moves the ball-chain hole upwards by means of the elasticity and the ball-chain hole is engaged with a fixing step 71 on a rear face of a cover which is coupled onto the bottom of the elastic gear 20 so as to restrict the rotation of the elastic gear 20.

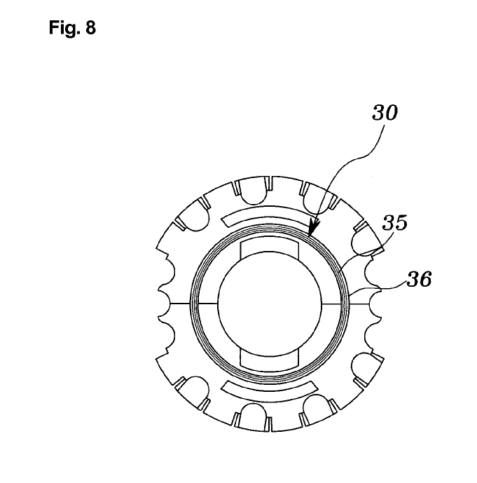

The elasticity-acting section 30, as illustrated in FIG. 8, has a circular insertion groove 36 on one surface of the elastic gear 20, which is divided into two or more divisions, into which groove a circular leaf spring 35 is fixedly inserted.

The leaf spring 35 may be a single-piece spring, or otherwise be a multi-piece spring so that the multi-piece parts are mounted into the divisions of the elastic gear 20 so as to move the divisions upwards to thereby prevent the elastic gear 20 from rotating.

The elasticity-acting section is configured such that a plastic elastic plate or clip type spring shaped like a ‘ [symbol] ’ is engaged with the center portion of the elastic gear 20, which is divided into two or more divisions and then are engaged with each other, so that the upper half body 21 or some divisions 20a of the elastic gear are moved upwards to thereby prevent the elastic gear 20 from rotating.

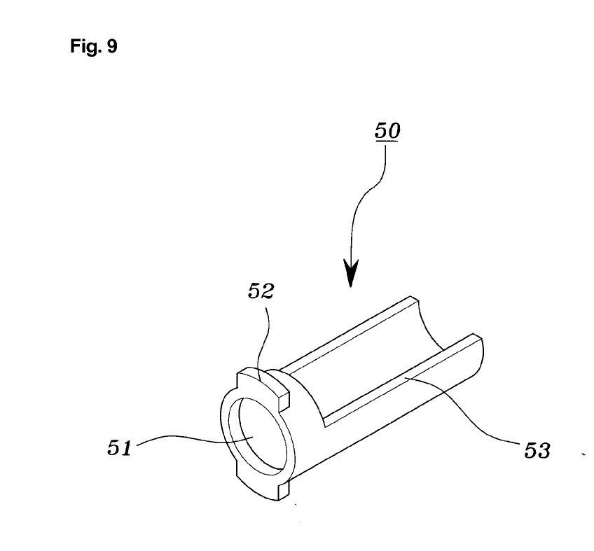

A rotating section 50 is inserted into the coupling hole 25 of the elastic gear 20, which has the elasticity-acting section of diverse forms. As illustrated in FIG. 9, the rotating section 50 includes a body having a center through-hole 51, symmetrically opposite engaging protrusions 52 on the outer circumference, and a semi-cylindrical portion 53 extending in a lengthwise direction and an upper portion of which is removed. The engaging protrusion 52 of the rotating section 50 is engaged with the engaging recess 24 of the elastic gear 20.

The engaging protrusions 52 are closely engaged with the inside of the engaging recesses 24 of the elastic gear 20 so as to prevent the elastic gear 20 from deviating and assist accurate movement in a vertical direction.

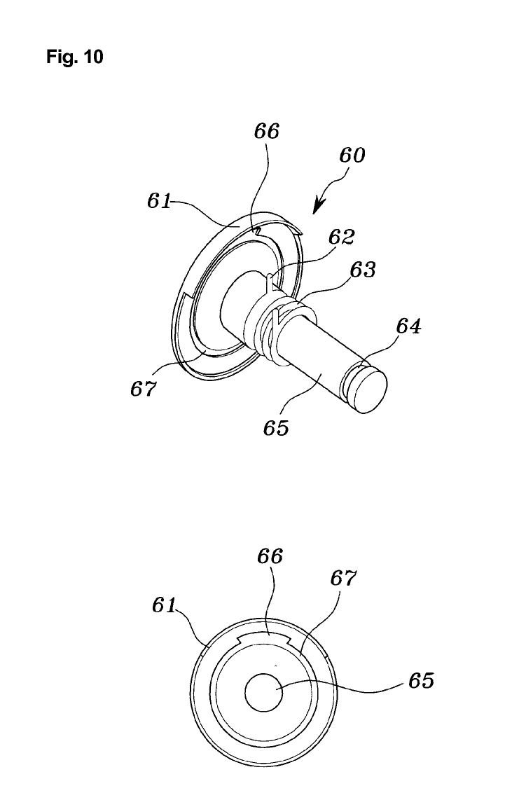

The fixing plate 60 is inserted and mounted into the through-hole 51 of the rotating section 50 as illustrated in FIG. 10.

The fixing plate 60 has a retaining protrusion 61 on the outer circumference, a spring 63 having an engaging pin 62 at the middle portion, and a fixing axis 65 having a leading O-ring groove 64.

The fixing plate 60 is also provided on the front surface with a circular guide recess 67 having an arcuate restriction groove 66 into which the guide protrusion 26 of the elastic gear 20 is inserted so as to restrict the rotation of the elastic gear.

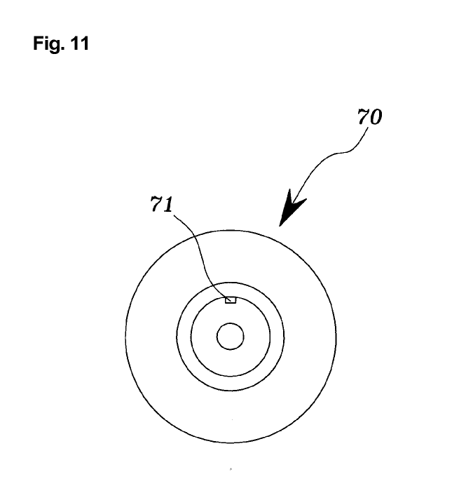

The fixing plate 60 is covered with the cover 70, which has an elongate fixing step 71, which protrudes downwards from the inner circumference in a longitudinal direction as illustrated in FIG. 11.

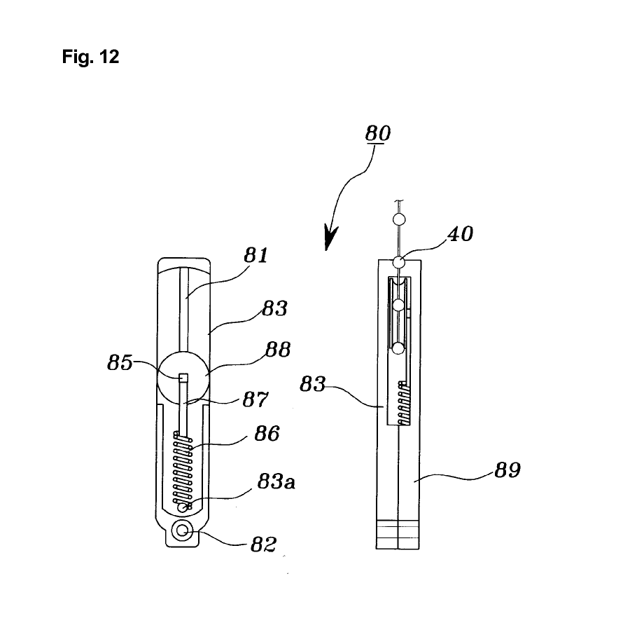

In the state where the ball chain 40 is engaged with the ball-chain holes 23 on the outer circumference of the elastic gear 20, the safety hook 80 is engaged with the lower portion of the ball chain 40 as illustrated in FIG. 12.

The safety hook 80 has a casing 83 in which a guide groove 81 is provided in a vertical direction at the middle portion of the inside and a bolt hole 82 is provided at the lower portion.

A rotating carrying portion 88 is rotatably mounted onto an axis 85 having a coupling groove 84, to which the ball chain 40 is coupled, at the end of the guide groove 81 of the casing 83, and a fixing rod 87 is provided below the axis 85 and to which an upper end of the elastic spring 86 is coupled.

A fixing step 83a is provided at the lower portion of the casing 83, to which step a lower end of elastic spring 86, which is coupled to the fixing rod 87, is fixedly mounted.

Then, a cover 89 is coupled onto the upper surface of the casing 83 such that the ball chain 40 is still engaged with the outer surface of the rotating carrying portion 88.

Here, the elastic spring 86 is maintained in a stretched state, so that the guide protrusion 26 of the elastic gear 20 is inserted into the restricting groove 66 of the fixing plate 60 so as to restrict the rotation of the elastic gear 20.

Referring again to FIG. 3, the upper half body 21 of the elastic gear 20 is moved upwards by means of elasticity of the elastic spring 31 of the elasticity-acting section 30 so that the guide protrusion 26 of the elastic gear 20 is inserted into the restricting groove 66 of the fixing plate 60 so as to restrict the rotation of the elastic gear 20.

Here, the elastic spring 86 of the safety hook 80 which is mounted to the ball chain 40 is maintained in a stretched state.

Such a state is an initial state of the roller blind apparatus in which a roller blind is not operable.

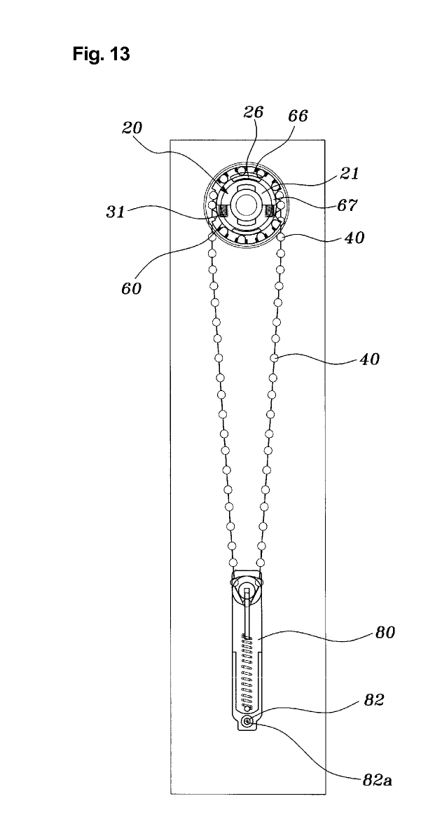

In the initial state, when a user holds the safety hook 80, which is mounted to the ball chain 40, and draws it down and fastens it to a fixing bolt 82a, which is provided on a wall face or a window frame, using a fixing hole 82, as illustrated in FIG. 13, the upper half body 21 of the elastic gear 20 is moved down so that the guide protrusion 26 escapes from the restricting groove 66 of the fixing plate 60, thereby releasing the interrupted state.

In this state, when the ball chain 40 is continuously drawn out, the elastic gear 20 rotates at 360° along the guide recess 67 of the fixing plate 60 while the lower half body 22 is not separated downwards, so that the roller blind is rolled out downwards.

Since the roller blind is operated only when the safety hook 80 is fixed after being drawn out tight, if a user releases the fixed state of the safety hook 80, the operation of the roller blind is immediately stopped, and the ball chain 40 is not operated. Thus, the user can use the roller blind apparatus only after fixing the safety hook 80, so that a safety accident can be completely prevented.

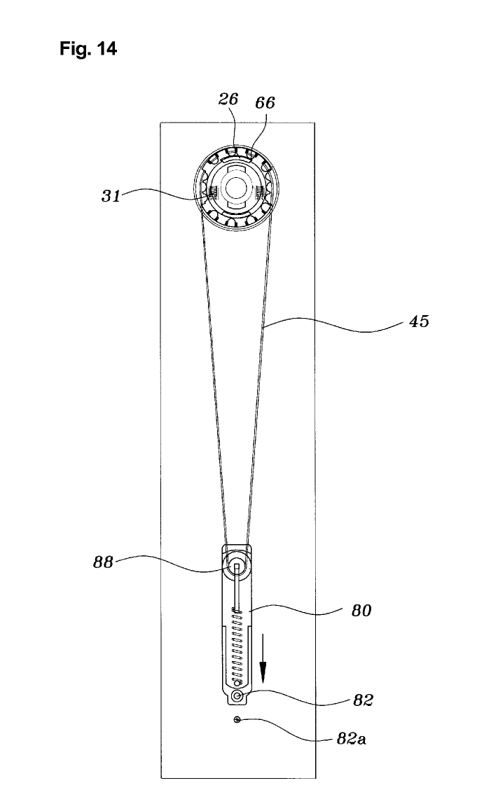

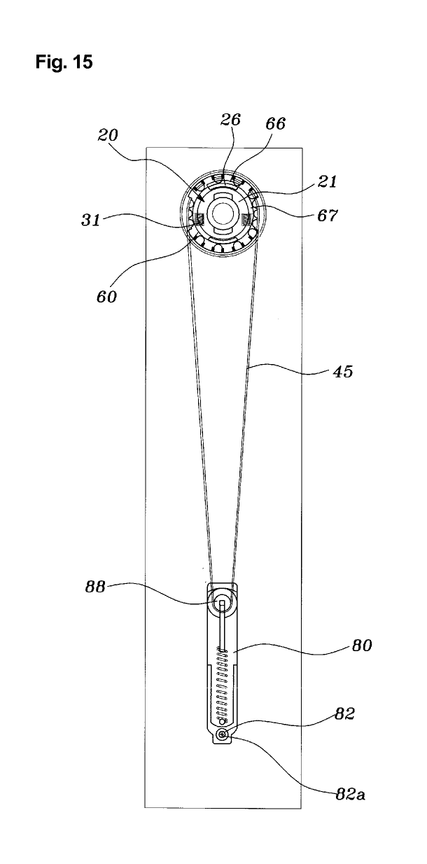

As illustrated in FIGS. 14 and 15, a cord wire 45 may be coupled with the outer circumference of the elastic gear 20, instead of the ball chain.

After the cord wire 45 is coupled with the rotating carrying portion 88 of the safety hook 80, the safety hook 80 is drawn down and the bolt hole 82 of the safety hook 890 is fastened to the fixing bolt 82a.

Here, the cord wire 45 becomes tight to the outer circumference of the lifted upper half body 21 of the elastic gear 20, so that it causes rotation without slippage from the elastic gear 20.

Then, the lower half body 22 is moved down so that the guide protrusion 26, which was restricted in the restricting groove 66 of the fixing plate 60, becomes a freely rotatable state.

In this state, when the cord wire 45 is continuously drawn down, the guide protrusion 26 of the elastic gear 20 rotates along the guide recess 67 of the fixing plate 60, so that the roller blind can be moved freely in a vertical direction.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A child-resistant roller blind apparatus comprising:
an elastic gear having at least symmetrical upper and lower gear half bodies or divisions to be coupled with each other, each body having a plurality of ball-chain holes on the outer circumference, a half coupling hole with an engaging recess on the inner circumference, and an arcuate protrusion on the surface;
an elasticity-acting section having one or more engaging protrusions on the upper half body for receiving a compression spring therein, and one or more engaging grooves on the lower half body for receiving the engaging protrusions therein, so that, when moved upwards by means of the elasticity by the compression spring, the upper half body prevents the elastic gear from rotating; and
a safety hook which has elasticity by a spring and is mounted on a ball chain, which is engaged with the ball-chain holes of the elastic gear, and then pulled down and fixedly connected to a wall surface so that interruption in rotation of the elastic gear is released by the tension of the ball chain and is able to rotate.

2. The child-resistant roller blind apparatus according to claim 1, wherein the elastic gear includes two or more divisions.

3. The child-resistant roller blind apparatus according to claim 1 or 2, wherein one or more ball-chain holes among the ball-chain holes provided on the outer circumference of the elastic gear, which is divided into two or more divisions, is moved upwards by means of elasticity of a spring and is engaged with a fixing step provided on a rear surface of a cover which is coupled onto the bottom of the elastic gear, so as to restrict the rotation of the elastic gear.

4. The child-resistant roller blind apparatus according to claim 1 or 2, wherein the elasticity-acting section includes an insertion groove on the surface or the inside of the elastic gear, which has two or more divisions engaged with each other, and a circular one-piece leaf spring or a circular multi-piece leaf spring, which is inserted into the insertion groove so as to move a certain portion of the elastic gear upwards to prevent the elastic gear from rotating.

5. The child-resistant roller blind apparatus according to claim 1 or 2, wherein the elasticity-acting section includes a plastic elastic plate which is engaged with the elastic gear, which has two or more divisions engaged with each other, so as to move a certain portion of the elastic gear upwards to prevent the elastic gear from rotating.

6. The child-resistant roller blind apparatus according to claim 1 or 2, wherein the elasticity-acting section includes a clip type spring shaped like a ‘ [symbol] ’ so as to move a certain portion of the elastic gear upwards to prevent the elastic gear from rotating.

7. The child-resistant roller blind apparatus according to claim 1, comprising a fixing plate which includes a guide recess along which the guide protrusion of the elastic gear moves at 360% the guide recess having a restricting groove allowing the lower half body to deviate downwards from an original position.

8. The child-resistant roller blind apparatus according to claim 1, wherein a cord wire is engaged with the ball-chain holes of the elastic gear, instead of the ball chain, and to the lower portion of the cord wire, the safety hook is connected such that the cord wire and the elastic gear are in close contact with each other at a contact area without slippage, using the tension of an elastic spring provided in the safety hook.

9. The child-resistant roller blind apparatus according to claim 1, wherein the safety hook includes:
a casing in which a guide groove is provided in a vertical direction at the middle portion of the inside and a bolt hole is provided at the lower portion;
a cover fixedly mounted on the upper surface of the casing;
a rotating carrying portion coupled with the guide groove of the casing and having at the center portion a fixing rod which is provided with an axis having a coupling groove, to which the ball chain is coupled, and a spring at the opposite side of the axis; and
a fixing step which is provided at the lower portion of the inside of the casing and to which the elastic spring is fixedly mounted.
